(19) United States
(12) Patent Application Publication
(10) Pub. No.: US 2019/0165344 A1
(43) Pub. Date: May 30, 2019

(54) TAMPER-RESISTANT BATTERY PACK

(71) Applicant: Nova Lumos Ltd., Netanya (IL)

(72) Inventors: Nir NITZANI, Kefar Sava (IL); David VORTMAN, Tzur Moshe (IL); Nir MAROM, Tzur Moshe (IL)

(73) Assignee: Nova Lumos Ltd., Netanya (IL)

(21) Appl. No.: 16/203,098

(22) Filed: Nov. 28, 2018

Related U.S. Application Data
(60) Provisional application No. 62/592,521, filed on Nov. 30, 2017.

(51) Int. Cl. H01M 2/10; H01M 10/42; H01M 2/20; H01M 10/48

(52) U.S. Cl. CPC H01M 2/1066; H01M 10/4257; H01M 2/341; H01M 10/482; H01M 10/486; H01M 2/204

(57) ABSTRACT

A battery pack includes a protective circuit module (PCM) including a first incoming power terminal and a second outgoing power terminal; a first pouch battery including a third power terminal and a fourth power terminal, wherein the third power terminal is electrically connected to the first power terminal; and a protective enclosure including a base plate and a wall extending perpendicularly from the base plate, wherein the PCM and a portion of the first pouch battery are disposed in the protective enclosure, wherein the portion of the first pouch battery includes the third power terminal and the fourth power terminal that cannot be accessed directly, wherein the PCM is affixed to the base plate, wherein the second power terminal of the PCM and at least one of the third power terminal and the fourth power terminal of the first pouch battery extend beyond the wall of the protective enclosure.

### CROSS-REFERENCE TO RELATED APPLICATIONS

This application claims the benefit of U.S. Provisional Application No. 62/592,521 filed on Nov. 30, 2017, the contents of which are hereby incorporated by reference.

### TECHNICAL FIELD

The present disclosure relates generally to securing power cells, and in particular to securing battery packs against tampering.

### BACKGROUND

With modern advances in electronics technology, battery life has become increasingly important. As a result, batteries that are simple, flexible, and lightweight have become highly desirable. Batteries including cells disposed in pouches (“pouch batteries”) provide high packaging efficiencies that allow designers and engineers to create devices which are not limited by the form factor of the energy element of the electronic device. A pouch cell typically includes conductive foil tabs welded to electrodes, thereby allowing for electrical connections outside of the pouch for transferring electricity while the battery remains fully sealed. The pouch provides a soft pack that allows for reducing weight of the battery.

As pouch batteries are useful and relatively expensive, there is a market for repurposing such batteries, for example by attempting to bypass battery management systems and accessing the cells directly. Thus, pouch batteries are frequent targets of tampering attempts. However, manufacturers of batteries typically intend for the batteries to work with certain devices, and often to only work under certain conditions.

To enforce their intended uses, manufacturers often use systems to prevent unauthorized use. For example, lithium-ion polymer batteries may include protective circuit modules (PCMs) or battery management systems (BSMs) connected to a pouch battery. These protective devices may be configured to allow access to authorized voltages, currents, or other authorized measures of energy. To subvert these protective devices, a malicious user may attempt to hack or bypass them.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a battery pack. The battery pack comprises: a protective circuit module (PCM) including a first power terminal and a second power terminal, wherein the first power terminal is an incoming power terminal and the second power terminal is an outgoing power terminal; a first pouch battery including a third power terminal and a fourth power terminal, wherein the third power terminal of the first pouch battery is electrically connected to the first power terminal of the PCM; and a protective enclosure including a base plate and a wall extending perpendicularly from the base plate, wherein the PCM and at least a portion of the first pouch battery are disposed in the protective enclosure, wherein the at least a portion of the first pouch battery includes the third power terminal and the fourth power terminal, wherein the third power terminal and the fourth power terminal disposed in the protective enclosure cannot be accessed directly, wherein the PCM is affixed to the base plate, wherein the second power terminal of the PCM and at least one of the third power terminal and the fourth power terminal of the first pouch battery extend beyond the wall of the protective enclosure.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a top side isometric view of a protection circuit module implemented according to an embodiment.

FIG. 2A is a bottom left side isometric view of a tamper-resistant battery pack according to an embodiment.

FIG. 2B is a top right side isometric exploded view of the tamper-resistant battery pack according to an embodiment.

FIG. 3 is a bottom right isometric view of multiple pouch batteries arranged according to an embodiment.

FIG. 4 is a flowchart illustrating a method for assembling a tamper-resistant battery pack according to an embodiment.

FIG. 5 is a schematic diagram of a battery management system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a tamper-resistant battery pack. The tamper-resistant battery pack includes a protection circuit module, a protective enclosure, and one or more pouch batteries. The PCM includes an incoming first power terminal and an outgoing second power terminal. A first pouch battery includes a third power terminal and a fourth power terminal. The protective enclosure includes a base plate and a wall extending perpendicularly from the base plate. The PCM and at least a portion of the first pouch battery are housed in the protective enclosure such that at least the second outgoing power terminal of the PCM and the third or fourth power terminal of the first pouch battery extend from the wall of the protective enclosure.

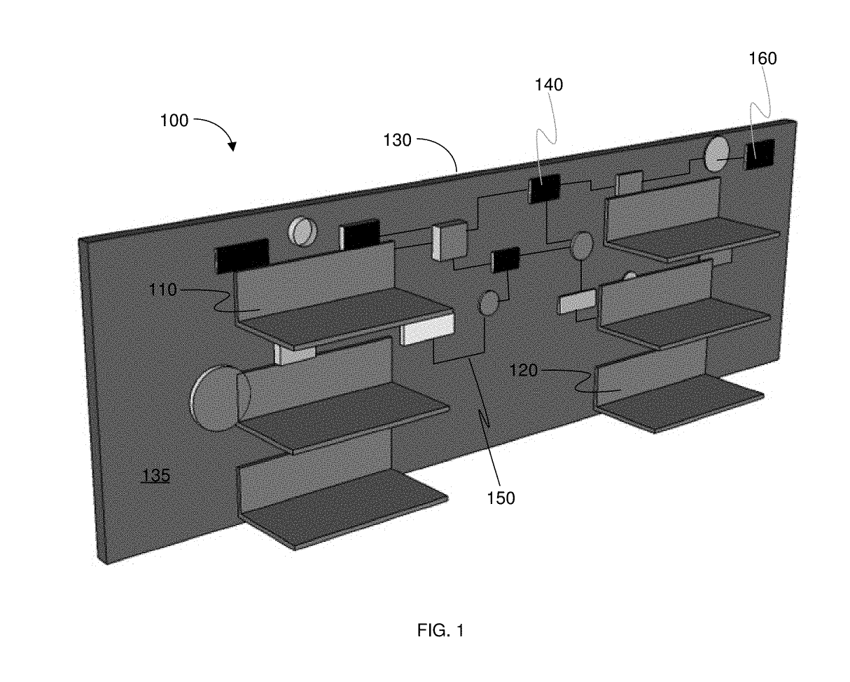

FIG. 1 is an example top side isometric view of a protection circuit module (PCM) 100 utilized for a tamper-resistant battery pack according to an embodiment.

In the example implementation shown in FIG. 1, the PCM 100 includes a first terminal 110 and a second terminal 120 for connecting to terminals of one or more pouch batteries (not shown in FIG. 1). The first and second terminals 110 and 120 may be utilized to create a circuit with terminals of pouch batteries (not shown in FIG. 1). As a non-limiting example, when the PCM 100 is electrically connected to a first pouch battery including a third terminal and a fourth terminal as well as to a second pouch battery including a fifth terminal and a sixth terminal, the first terminal 110 of the PCM may be connected to the third terminal of the first pouch battery, the fourth terminal of the first pouch battery may be connected to the fifth terminal of the second pouch battery, and the sixth terminal of the second pouch battery may be connected to the second terminal 120 of the PCM 100.

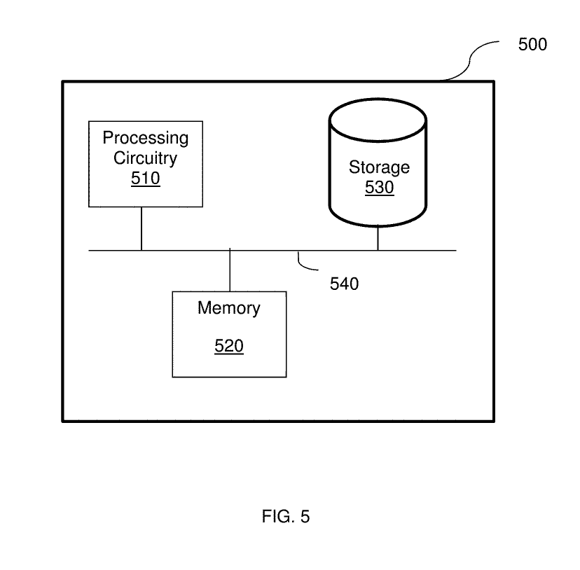

The PCM 100 may include a battery management system (BMS) 160. The BMS 160 is configured to perform one or more battery management functions (e.g., any of the battery management functions discussed further below with respect to FIG. 5) to protect the batteries of a protected battery pack (not shown in FIG. 1) and to ensure operation in a safe operating area (e.g., based on over-current protection, under-voltage protection, detection of current leakage, detection of over-temperature and under-temperature, and the like). The BMS 160 may be connected to one or more sensors 140. An example battery management system is described further herein below with respect to FIG. 5.

The PCM 100 includes a substrate such as a printed circuit board (PCB) 130 having a first side 135 and a second side (not shown) opposite to the first side. The components of the PCM 100 are disposed on the PCB 130. The PCB 130 may be single-sided, double-sided, or multi-layered; and may be flexible or rigid. As a non-limiting example, one or more terminals may be disposed on each of the first side 135 and the second side. In the example implementation shown in FIG. 1, the first terminal 110 and the second terminal 120 are disposed on the first side 135.

In an embodiment, the PCM 100 includes a switching circuitry 150 configured to connect the PCM 100 to pouch batteries. In some implementations, the switching circuitry 150 is configured to disconnect one or more pouch batteries from the PCM 100.

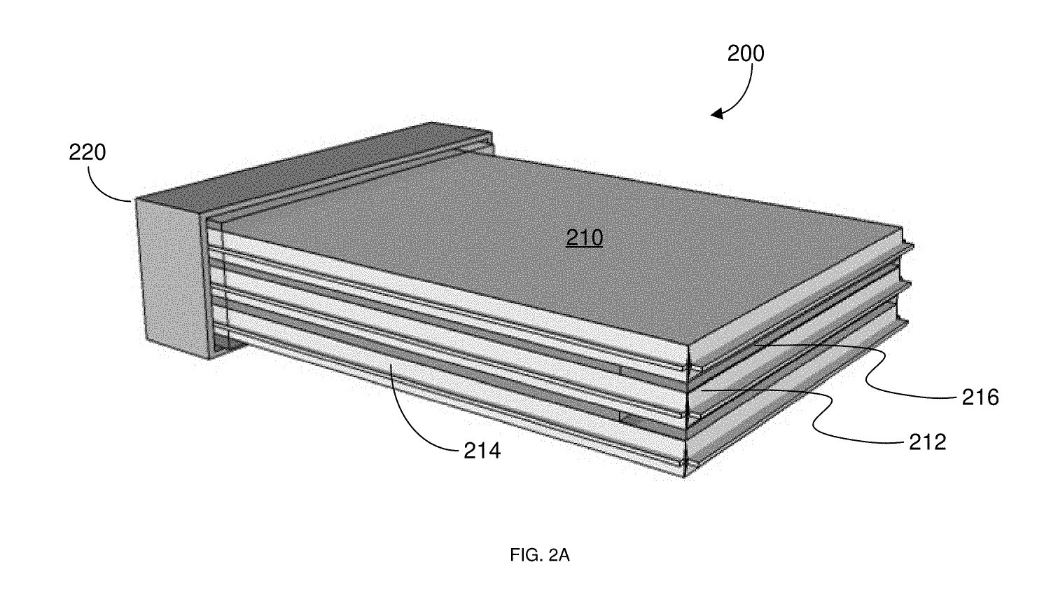

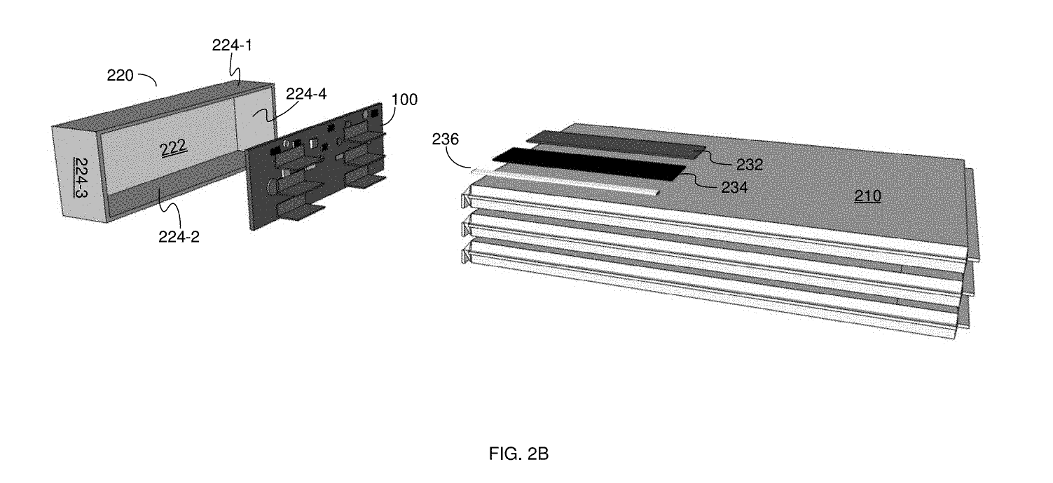

FIG. 2A shows an example bottom left isometric view of a tamper-resistant battery back 200 and FIG. 2B shows an example top right isometric exploded view of the tamper-resistant battery pack 200 according to an embodiment.

As shown in FIG. 2A, the battery pack 200 includes a first pouch battery 210, a second pouch battery 212, and a third pouch battery 214. Each of the pouch batteries 210, 212, and 214 is at least partially enclosed by an enclosure 220. The enclosure 220 is a protective enclosure that may be made of, for example, a cast metal, a hardened plastic, carbon fiber, a composite material, and the like. The pouch batteries 210, 212, and 214 may each include lithium-polymer cells encased in a flexible foil cover.

In an embodiment, power terminals of each of the pouch batteries 210, 212, and 214, is disposed in the enclosure 220 such that their respective cells (e.g., the power terminals 310, 312, 314, and 316, not shown in FIG. 2A) cannot be accessed directly. As shown in FIG. 2A, no power terminals can be seen from outside the enclosure 220. In various embodiments, the enclosure 220 may be further secured to prevent tampering by, for example, including components that are adapted to cause damage to pouch batteries upon an attempt to tamper with the enclosure (e.g., corrosive or volatile elements), including materials for occupying otherwise unoccupied space in the enclosure (e.g., a hardening agent disposed in space between the power terminals so as to fill such space), and the like.

As shown in FIG. 2B, the enclosure 220 further includes a base plate 222 to which the PCM 100, FIG. 1, may be affixed. In some implementations, one of the pouch batteries (e.g., the first pouch battery 210), may be affixed to the base plate 222 and coupled with the PCM 100 such that at least a portion of the pouch battery, the PCM 100, and at least a portion of another pouch battery (e.g., the second pouch battery 212) are enclosed by the enclosure 220. In the example implementation shown in FIGS. 2A and 2B, when assembled, the PCM 100 and a portion of each of the pouch batteries 210, 212, and 214 are disposed in the enclosure 220.

The enclosure 220 also includes a wall extending from the base plate 222 to form the enclosure 220. In the example implementation shown in FIGS. 2A and 2B, the wall is made of a top wall portion 224-1, a bottom wall portion 224-2, a left-side wall portion 224-3, and a right-side wall portion 224-4. The wall as shown in FIGS. 2A and 2B has a rectangular cross section. In other implementations (not shown), a wall portion with another polygon-shaped cross-section may be used.

Each of the pouch batteries 210, 212, and 214 may change volume according to its state of charge or discharge. To this end, a volume of the enclosure 220 may be sufficiently large to accommodate such changes in volume (e.g., where the volume of the enclosure is large enough to contain the respective portion of each of the pouch batteries 210, 212, and 214 at its largest respective volume).

In an embodiment, the enclosure 220 includes elements 216 such as corrosive elements, volatile elements, or both. Each of the elements 216 is adapted to cause rupturing of one or more of the pouch batteries 210, 212, and 214 when the battery pack 200 is tampered with. In the example implementation shown in FIG. 2, the elements 216 are disposed outside of the protective enclosure 220.

In an embodiment, the enclosure 220 includes an encapsulating material (not shown). The encapsulating material may be adapted such that it adheres to the enclosure 220; to a coating (e.g., a polyamide coating) of one of the pouch batteries 210, 212, or 214; or both. The encapsulating material may be, but is not limited to, polyurethane, polysulfide, epoxy, or a combination thereof. In a further embodiment, the encapsulating material may be subject to curing into a hardened state at a temperature that is lower than the maximum temperature that the pouch batteries 210, 212, and 214 can be exposed to (e.g., a maximum temperature above which the pouch batteries 210, 212, 214 begin to degrade). As a non-limiting example, for a lithium pouch battery, the encapsulating material may undergo curing into a hardened state at a temperature below 60 degrees Celsius.

In an embodiment, the battery pack 200 includes external load power terminals 232 and 234 as well as a data terminal 236. Each of the first power terminal 232 and the second power terminal 234 provides power from the battery pack 200 to an external load (not shown). The first power terminal 232 and the second power terminal 234 extend from the enclosure 220 to allow connection of the battery pack 200 to an external load or external power management system (not shown). The data terminal 236 may provide information, measurements, and the like, to a control unit (not shown).

In some implementations, the enclosure 220 may include an authenticator module (not shown) for authenticating the battery pack 200. The authentication may be used to ensure that the battery pack 200 is only used by authorized users. In some implementations, the enclosure 220 may be further filled with a hardening agent (not shown) after the other components of the batter pack 200 are disposed in the enclosure 200. The hardening agent is used to secure the components in place and may be, for example, epoxy, polyurethane, and the like.

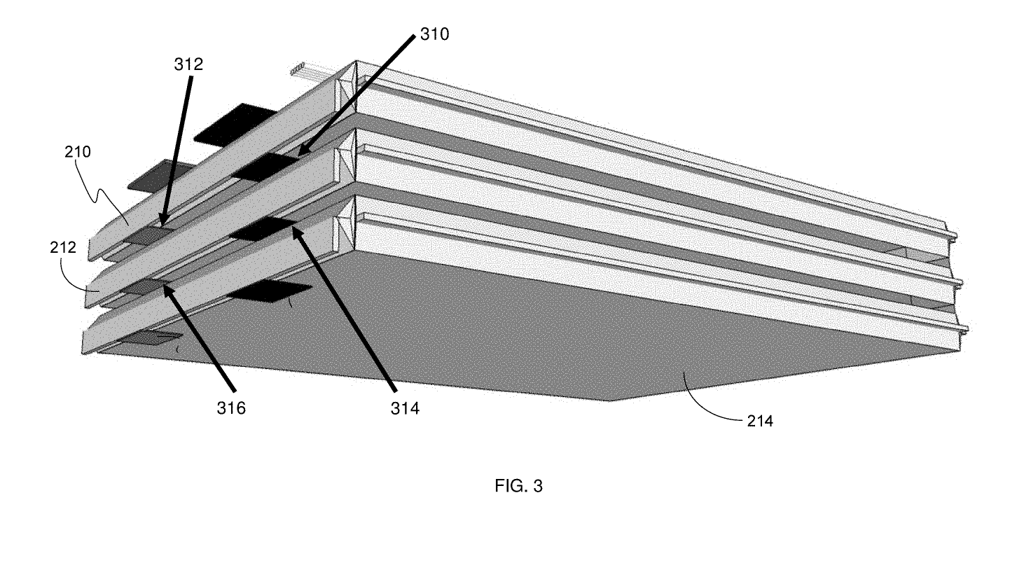

FIG. 3 is an example bottom right isometric view of pouch batteries 210, 212, and 214 arranged according to an embodiment. Each of the pouch batteries 210, 212, or 214 includes two power terminals such as a third power terminal 310 and a fourth power terminal 312 of the first pouch battery 210, a fifth power terminal 314 and a sixth power terminal 316 of the second pouch battery 212, and the like. Each of the power terminals is adapted to connect to another pouch battery (e.g., the third power terminal 310 of the first pouch battery 210 may be used to connect to the second pouch battery 212 or the third pouch battery 214) or to the PCM 100. In some implementations, both the first and second terminals of any of the pouch batteries 210, 212, and 214, may be connected to the PCM 100 while some of the pouch batteries 210, 212, and 214 having their first and second power terminals connected to the other pouch batteries of the pouch batteries 210, 212, and 214 (for example, the third power terminal 310 and the fourth power terminal 312 of the first pouch battery 210 may both be connected to the PCM 100 while a fifth power terminal 314 and a sixth power terminal 316 of the second pouch battery 212 may be connected to the pouch battery 210 and to the third pouch battery 214, respectively). Other connection arrangements may be used without departing from the disclosed embodiments.

In an embodiment, the PCM 100 may include a switching circuitry (not shown) adapted to enable, for example, using the pouch battery 210 to supply power to a first load (not shown), to charge pouch battery 212, or both simultaneously.

It should be noted that FIGS. 2A, 2B, and 3 are depicted as including 3 pouch batteries 210, 212, and 214 merely for illustrative purposes and without limitation on the disclosed embodiments. It is noted that any number of such pouch batteries may be used without departing from the scope of the disclosure. When multiple pouch batteries are used, the PCM 100 may be disposed between a first pouch and a second pouch of the multiple pouches to prevent full access to at least some of the pouches. Further, in some implementations, each pouch battery may be affixed to or may include its own PCM, and each such PCM may be connected to a BMS implemented, for example, on the PCB 130.

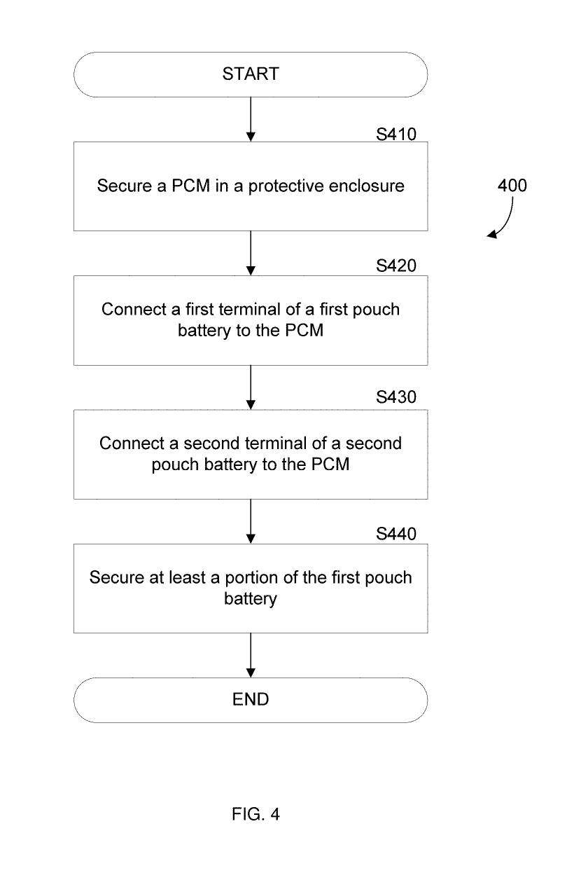

FIG. 4 is an example flowchart illustrating a method for assembling a tamper-resistant battery pack according to an embodiment.

At S410, a PCM is secured in a protective enclosure. The enclosure is adapted to include at least the PCM and a portion of a first pouch battery. Specifically, the enclosure is sized so as to allow for inclusion of the PCM and the portion of the first pouch battery. The PCM includes first and second power terminals for connecting to the first pouch battery. The first pouch battery may include third and fourth power terminals.

At S420, the first pouch battery is connected to the PCM. Specifically, in an example implementation, the third power terminal of the first pouch battery may be connected to the first power terminal of the PCM.

At optional S430, a second pouch battery is connected to the PCM. In an example implementation, the second pouch battery includes a fifth power terminal and a sixth power terminal, and the fifth power terminal may be connected to the second power terminal of the PCM. In some implementations, S430 may be skipped such that only the first battery pouch is connected to the PCM. In such implementations, the PCM may have a single power terminal extending therefrom and beyond the enclosure, and a power terminal of the second pouch battery that is not connected to the PCM likewise extends beyond the enclosure.

At S440, at least a portion of the first pouch battery is secured within the enclosure of the PCM such that direct access to its power terminals is not possible. In some implementations, S440 may further include encasing the pouch batteries, the PCM, or both, in a hardening agent such as epoxy resin.

It should be noted that only a single power terminal of each of the first and second pouch batteries is described as being connected to the PCM with respect to S420 and S430, but that, in some implementations, both terminals of each pouch battery may be connected to the PCM. Additionally, in some implementations, any of the pouch batteries may be connected to each other or to other pouch batteries and others may only be connected to the PCM. Moreover, in some embodiments, the first pouch battery and the second pouch battery may be the same battery.

FIG. 5 is an example schematic diagram of a battery management system 500. The battery management system 500 includes a processing circuitry 510 coupled to a memory 520, and a storage 530. In another embodiment, the components of the battery management system 500 may be communicatively connected via a bus 540.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 510 to perform the various processes described herein. Specifically, the instructions, when executed, cause the processing circuitry 510 to perform battery management functions such as, but not limited to, monitoring the state of each pouch battery (e.g., charge or discharge), performing measurements (e.g., of voltage, current, and the like), sending measurements to external components (e.g., via the bus 540), authenticating a protected battery pack, balancing among the pouch batteries, and the like. Measurements may be performed using, for example, the sensors 140, FIG. 1. The battery management functions may also include over-current protection, over-voltage and under-voltage protection, detection of leakage of current, detection of over-temperature and under-temperature, and the like.

The storage 530 may be magnetic storage, optical storage, and the like, and may be realized, for example, as flash memory or other memory technology, CD-ROM, Digital Versatile Disks (DVDs), or any other medium which can be used to store the desired information.

It should be understood that the embodiments described herein are not limited to the specific architecture illustrated in FIG. 5, and other architectures may be equally used without departing from the scope of the disclosed embodiments.

It should also be noted that various embodiments are described with respect to connections among components. Where the connected components are connected for the purpose of transferring power, such connection includes at least being electrically connected.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A battery pack, comprising:
a protective circuit module (PCM) including a first power terminal and a second power terminal, wherein the first power terminal is an incoming power terminal and the second power terminal is an outgoing power terminal;
a first pouch battery including a third power terminal and a fourth power terminal, wherein the third power terminal of the first pouch battery is electrically connected to the first power terminal of the PCM; and
a protective enclosure including a base plate and a wall extending perpendicularly from the base plate, wherein the PCM and at least a portion of the first pouch battery are disposed in the protective enclosure, wherein the at least a portion of the first pouch battery includes the third power terminal and the fourth power terminal, wherein the third power terminal and the fourth power terminal disposed in the protective enclosure cannot be accessed directly, wherein the PCM is affixed to the base plate, wherein the second power terminal of the PCM and at least one of the third power terminal and the fourth power terminal of the first pouch battery extend beyond the wall of the protective enclosure.

2. The battery pack of claim 1, further comprising:
a second pouch battery including a fifth power terminal and a sixth power terminal.

3. The battery pack of claim 3, wherein the fourth power terminal of the first pouch battery is electrically connected to the fifth power terminal of the second pouch battery.

4. The battery pack of claim 3, wherein the PCM further includes a switching circuitry and a seventh power terminal, wherein the seventh power terminal is an incoming power terminal, wherein the seventh power terminal of the PCM is electrically connected to the fifth power terminal of the second pouch battery.

5. The battery pack of claim 3, wherein the fourth power terminal of the first pouch battery is electrically connected to the second power terminal of the PCM.

6. The battery pack of claim 1, wherein the PCM further includes an eighth power terminal, wherein the eighth power terminal is an incoming power terminal, wherein the fourth power terminal of the first pouch battery is electrically connected to the eighth power terminal of the PCM.

7. The battery pack of claim 1, wherein the PCM further includes a circuitry configured for at least one of: over-voltage protection, under-voltage protection, over-current protection, external communication, thermal protection, and short circuit protection.

8. The battery pack of claim 1, wherein the PCM further includes at least one of: a temperature sensor, and a pressure sensor.

9. The battery pack of claim 1, wherein the protective enclosure further includes at least one of: a volatile element, and a corrosive element.
